(19) United States
(12) Patent Application Publication
(10) Pub. No.: US 2025/0031009 A1
(43) Pub. Date: Jan. 23, 2025

(54) SYSTEMS AND METHODS FOR INFORMED EMERGENT INCIDENT RESPONSE

(71) Applicant: Tactical Wayfinding LLC, Louisville, KY (US)

(72) Inventors: Troy McDaniel, Floyds Knobs, IN (US); Stephen S. Baldwin, Lanesville, IN (US)

(73) Assignee: Tactical Wayfinding LLC, Louisville, KY (US)

(21) Appl. No.: 18/224,714

(22) Filed: Jul. 21, 2023

(51) Int. Cl. H04W 4/021; H04W 4/90

(52) U.S. Cl. CPC H04W 4/021; H04W 4/90

(57) ABSTRACT

Certain aspects of the present disclosure provide techniques for incident response by a dispatch computing device, includes receiving an incident response request comprising a primary location and an incident specific location within the primary location; retrieving a tactical map for the primary location from the one or more memories, the tactical map comprising an aerial image of the primary location and a plurality of zones overlaid on the aerial image, the plurality of zones corresponding to structural areas of one or more buildings at the primary location; determining one or more zones of the plurality of zones corresponding to the incident specific location; and causing a display device to display the tactical map comprising the aerial image overlaid with the plurality of zones and a graphical element accentuating the one or more zones determined to correspond to the incident specific location.

### INTRODUCTION

### Field of the Disclosure

Aspects of the present disclosure relate to informed emergent incident response systems and methods, and more particularly, to techniques for generating and providing tactical maps to responders for improved informed emergent incident response.

### DESCRIPTION OF RELATED ART

When an emergent event such as a fire, a medical emergency, an intruder, or the like occurs, a witness typically calls 911 and is connected with a dispatcher. The dispatcher collects relevant information pertaining to the emergent event from the witness. Based on the information, the dispatcher causes one or more emergency response services such as fire, police, medical, or the like to be dispatched to the location of the emergent event. The relay of information from the dispatcher to the one or more emergency responders is typically carried out through mobile communications such as cellular and/or radio and in some instances may include provisioning of information such as person-of-interest, hazmat information, and/or the like via a data link between the dispatcher and the one or more emergency responders.

### SUMMARY

One aspect provides a method for incident response by a dispatch computing device. The method includes receiving an incident response request comprising a primary location and an incident specific location within the primary location; retrieving a tactical map for the primary location from the one or more memories, the tactical map comprising an aerial image of the primary location and a plurality of zones overlaid on the aerial image, the plurality of zones corresponding to structural areas of one or more buildings at the primary location; determining one or more zones of the plurality of zones corresponding to the incident specific location; and causing a display device to display the tactical map comprising the aerial image overlaid with the plurality of zones and a graphical element accentuating the one or more zones determined to correspond to the incident specific location.

Another aspect provides a method for incident response by a responder computing device. The method includes receiving an incident response request to respond to an incident at a primary location; and displaying on a display device a tactical map for the primary location, wherein: the tactical map comprises an aerial image of the primary location and a plurality of zones overlaid on the aerial image, the plurality of zones corresponding to structural areas of one or more buildings at the primary location, and a graphical element accentuating one or more zones corresponding to an incident specific location within the primary location.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts a commination network.

FIG. 2 depicts a process flow of example communications between the requestor device, the dispatch device, and one or more responder devices.

FIG. 3 depicts a block diagram of an incident response system associated with the dispatcher.

FIG. 4 depicts a primary location selection menu.

FIG. 5 depicts an incident response dashboard.

FIG. 6 depicts another instance of the incident response dashboard.

FIG. 7 depicts another instance of the incident response dashboard.

FIG. 8 depicts another instance of the incident response dashboard.

FIG. 9 depicts a block diagram of an incident response system associated with the responder.

FIG. 10 depicts an incident response dashboard for a responder device.

FIG. 11 depicts a floor plan.

FIG. 12 depicts a method for incident response request by a dispatch device.

FIG. 13 depicts a method for incident response request by a responder device.

FIG. 14 depicts aspects of an example processing system corresponding to the dispatch device.

FIG. 15 depicts aspects of an example processing system corresponding to the responder device.

### DETAILED DESCRIPTION

Aspects of the present disclosure provide apparatuses, methods, processing systems, and computer-readable mediums for generating and providing tactical maps to responders for improved informed emergent incident response.

Emergency responders continue to benefit from the advancements in technology to aid in response efforts to protect, defend, and render aid to individuals involved in emergent incidents. For example, thermal imagers have improved search and rescue operations locate missing or trapped individuals, medical diagnostic equipment and other devices such as automated external defibrillators have improved lifesaving efforts at the scene of an incident, and non-lethal products have aided in the diffusion of hostile situations and apprehension of subjects. However, information regarding a situation continues to be a critical aspect of emergency response. Since emergent incidents can arise anywhere, it is difficult, if not impossible, for emergency responders to prepare and plan for all situations at multiple different locations. Accordingly, there is a need for rapid, updateable, accurate, and contextually relevant information that can be compiled and disseminated to emergency responders. For example, specific details of a location need to be able to be rapidly contextualized by an emergency responder with the type and details of the emergent incident that is unfolding.

When local, county, state and federal agencies are racing to the scene of an incident, they begin to receive information from dispatch regarding the situation. However, upon arrival they routinely assemble at the front door or alpha side of a structure to coordinate entry and response. This initial step of coordination is required because emergency responders are generally provided with basic information about the location and the type of emergency. Additionally, enroute and on the ground communication between emergency response services (e.g., fire, police, medical, and the like) and between jurisdictional levels such as city, county, state, and federal agencies are not universal which causes confusion and breakdown in response time.

Moreover, not all emergencies occur at the front door, so time is wasted as responders make their way to the actual point of emergency within the structure. Current techniques deployed by emergency responders upon arrival at a structure include implementing structural incident response navigation techniques such as identifying sides of a structure using terms such as Alpha, Bravo, Charlie, Delta, where the “Alpha” side is the front of the structure, the “Bravo” side is the left side of the structure, “Charlie” is the back of the structure and “Delta” is the right side of the structure. However, more precise structural designations and navigation will improve response time and efficiency in responding to emergent situations such that entry and navigation to an incident specific location within the structure at a primary location is needed to render time sensitive aid. For example, tactical entry to respond to an intruder or rapid navigation to an individual in medical distress benefit from technical improvements to the compilation and dissemination of location and structural information during the emergent incident as described herein. Aspects of the present disclosure provide technical solutions to contextualizing and incident and navigating to the same in order to reduce the overall response time to save lives.

Aspects of the present disclosure provide techniques for providing tactical maps to responders that deliver accurate and contextually relevant information directly to each of the emergency responders, for example, enroute to the incident.

### Aspects Relating to Generating Initial Tactical Map

To enable provisioning of tactical maps for use during an emergent incident, location surveys or assessments are conducted. As one example, a facility manager or owner, school district representative, hospital administrator, or the like, may request to subscribe to have a tactical map developed for their structures and campuses. An assessment form may be provided and completed by the requestor. The assessment form may be provided through a computing device and provide prompts for requests for information regarding structures and campuses of the requestor. Information such as floor plans, lockdown procedures or any other related information can be uploaded through software deployed by the computing system. The provided information is ultimately compiled with aerial imagery into an interactive tactical map. The interactive tactical map puts the information into a contextually relevant form that is made available to all emergency service responders at the time of an emergent incident. This is unique to information that is currently provided to responders.

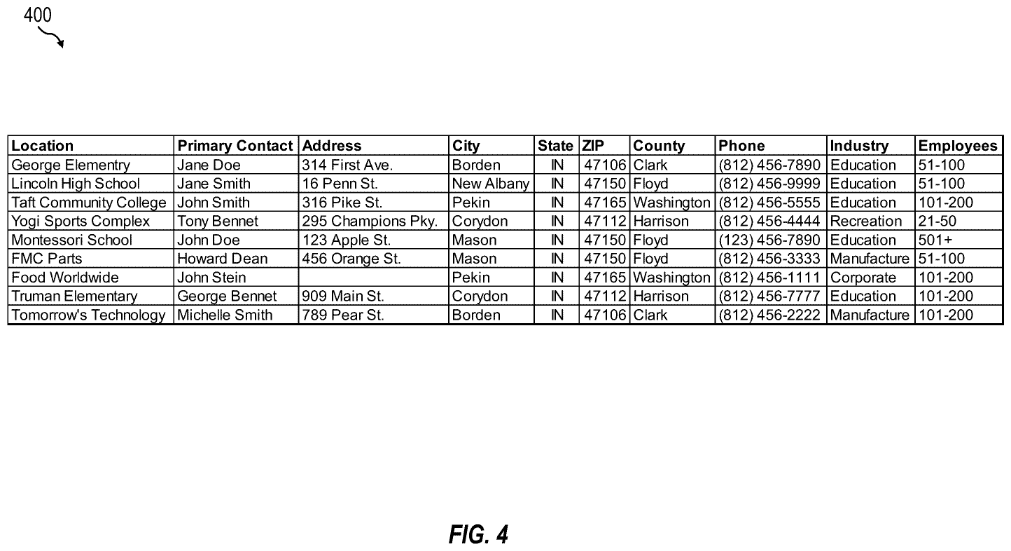

The aerial imagery, which may include a satellite or drone, based image of the structures and/or campuses are partitioned into a plurality of zones. The plurality of zones are structure specific zones. That is, a boundary of a zone corresponds to a structural feature of one or more buildings. For example, a school campus may include multiple structures, such as a gymnasium, a cafeteria, a library, administrative offices, classrooms, lecture halls, and/or the like which are collocated on a campus (e.g., a primary location). Each of the multiple structures may be interconnected and appear as a single building or multiple buildings interconnected by walkways, stairwells, tunnels, skywalks, parking lots, and/or the like. A first zone, Zone A (e.g., depicted in FIG. 4), may correspond to the administrative offices, and have a boundary that corresponds to the structural features (e.g., walls, walkways, floors, or the like) defining the collection of administrative offices. Likewise, other zones each may correspond to the structural features defining the boundary of each of the other structures located on the campus. The plurality of zones will be discussed in more detail herein. The plurality of zones defined by the partitioning process form an overlay that is aligned and combined with the aerial map to form the basis of the tactical map. A plurality of other features such as entrances, stairwells, elevators, and/or the like may be identified and associated with the zone of the plurality of zones in which they are located. The plurality of other features may further be annotated as visual indicators with the overlay and the aerial map.

The process of generating the tactical map further includes configuring the plurality of zones and the plurality of other features to be interactive. That is, selection of a zone or a feature on the tactical map by a user enables the user to obtain additional information pertaining to the selected zone and/or feature. For example, when a zone or feature is selected, the zone or feature is highlighted to indicate selection thereof. Furthermore, selection of the zone or feature may cause additional information relating to the selection to be presented on the aerial map or in a sub-pane adjacent to the display of the tactical map on a display device. The additional information may provide options for selecting and accessing a detailed floor plan of the selected zone, photos of the internals of the zone, information relating to specific areas within the zone, such as a list of room types, and/or the like. The aforementioned information may be generated and associated with the tactical map through the interactive submissions made by the requestor and/or an onsite zone assessment by an assessor who may conduct a walk through.

In addition to collecting additional information regarding each zone during the onsite, the onsite assessment may be used to customize the otherwise automatically generated boundaries of the plurality of zones. Additionally, the defined zones of the building may be physically labeled within the building(s). The zones can be marked along with the details of rooms and features within each zone such as offices, gymnasium, theater, cafeteria, classrooms, and/or the like. For example, when a 911 call is made (or other emergency communication is made through text message or other electronic communication), the caller can utilize the internal physical labels to identify the zone and/or any other detail of the room where the emergent issue is occurring. When the communication regarding the emergent incident is provided to the dispatch computing device, information included with the communication, such as voice or text references made to the zone labels as well as other information for example extracted using natural language processing is used to locate the caller and/or location of the emergent incident. In some instances, the dispatcher may extract the information from their communication with the caller and select the communicated zones and other features in an interactive displayed version of the tactical map on a dispatcher computing device.

In some aspects, each zone can be marked with a reflective exterior sign such as “Zone A”. Interior signage can mark both individual zones and zone transitions as needed for emergency responders aiding in their wayfinding. For example, moving into a multi hallway crossing, signage will include “A” on wall “A” with a signed marked “B” close by at the start of Zone “B.” Emergency responders will see both to know what zone they are leaving and what zone they are entering into. If there is a “T” in the hallway of 3 Zones, multiple signs may be visible, for example, signs Zone A/B and Zone A/C. The necessary signs are determined and noted during the onsite assessment.

The onsite assessment may also include identifying and confirming the location of external doors noted on the initial tactical map of campus. Similar to marking the zones, each door can be assigned a number along with a letter corresponding to the appropriate zone. Stairwells and elevators are also noted on the map to be included in the software mapping the tactical map. For multi-floor facilities, a notation system of labeling the zones with an annotation of the floor level, for example, Zone A1 (e.g., for first floor of Zone A), Zone A2 (e.g., for second floor of Zone A), Zone A3 (e.g., for third floor of Zone A), and the like can be used. Marked stairwells and elevators are flared (e.g., graphically accentuated) if an emergent incident is indicated as occurring on any floor other than the first floor thereby providing indication to the emergency responders an efficient route to the emergent incident via the tactical map. Furthermore, areas that include hazardous materials may also be noted on the tactical map by a graphical element accentuating the location of the hazmat at time of the onsite assessment and can be included in the client profile to be displayed as critical information to first responders when responding to an emergent incident. Each of the aforementioned features identified during the onsite assessment are integrated into the tactical map with a corresponding graphical element and linkage to their location and corresponding zone so that they may be interacted with by a dispatcher and/or responder using the tactical map. Each tactical map also include a client profile. The client profile may include information such as a name for the primary location (e.g., name of the school or business), a contact person, the address of the primary location (e.g., the street address, city, county, state, zip code), a contact phone number, the type of industry, the estimated population of persons located at the location, and/or the like.

In some aspects, once an onsite assessment is complete, a beta test may be conducted to confirm the mapping and information is correctly integrated into the tactical map and accessible by dispatchers and emergency responders. Additional signage may be located at the assessed location to indicate to others that the facility is protected by the herein described emergent incident response systems and methods. This may operate as a deterrent and/or indication to witnesses communicating with 911 to report an emergent incident.

Aspects of the present disclosure are directed to systems and methods for generating and providing tactical maps to responders for improved informed emergent incident response. The following will now describe these systems and methods in more detail with reference to the drawings and where like numbers refer to like structures.

### Aspects Related to the Incident Response System

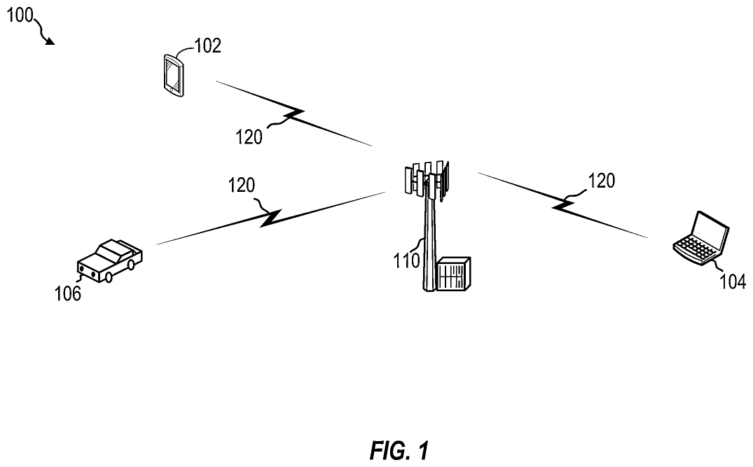

Referring now to FIG. 1, a communication network 100 is depicted. The communication network 100 provides for communications among and between a requestor device 102 capable of transmitting a request for emergency services in response to an emergent incident, a dispatch device 104, for example, operated at a 911 dispatch center and/or by a 911 dispatcher, and a responder device 106. Although only one device (e.g., the requestor device 102, the dispatch device 104, and the responder device 106) are depicted, multiple of each device may be in communication with each other via the communication network 100. The requestor device 102, the dispatch device 104, and the responder device 106, individually and collectively referred to as computing devices or devices, may include a cellular phone, smart phone, radio, laptop, personal digital assistant (PDA), satellite phone, tablet, smart device, wearable device, vehicle, or other similar devices. The devices communicate with each other via a terrestrial or non-terrestrial base station 110. Communications between the devices are facilitated by the base station through one or more communication links 120.

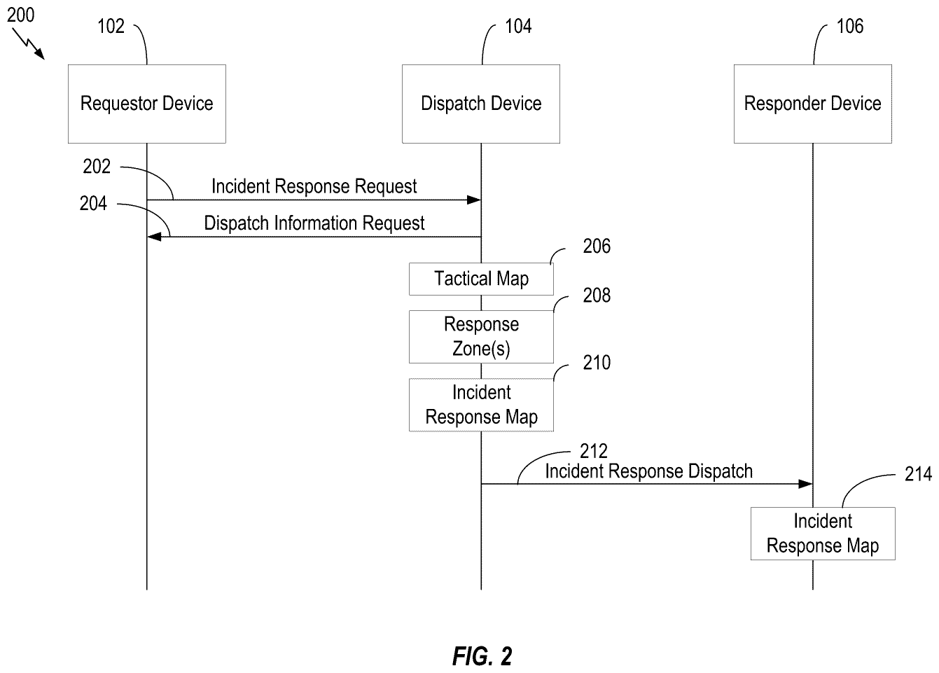

FIG. 2 depicts a process flow of example communications between the requestor device 102, the dispatch device 104, and one or more responder devices 106. At step 202, a requestor, with the requestor device 102, generates and transmits an incident response request to a dispatch device 104. The incident response request may be a voice call, a text or multimedia message, a mobile application based communication or the like. The dispatch device 104 receives the incident response request and, at step 204, may transmit a dispatch information request in response to the incident response request, thereby requesting additional information regarding the emergent incident indicated in the incident response request. Communication between the requestor device 102 and the dispatch device 104 may continue as the dispatcher operating the dispatch device 104 requests and obtains additional information regarding the emergent incident. The incident response request may include information such as a primary location of the emergent incident and an incident specific location at the primary location. The primary location may be a street address or a name of facility. The incident specific location include reference to a “Zone” and/or other location information such as gymnasium, cafeteria, lecture hall, administrator's office, or the like.

At step 206, the dispatch device 104 selects a tactical map for the primary location indicated in the incident response request. The dispatch device 104, at step 208, searches the tactical map for incident specific location information indicated by reference to a “Zone” viewed by a physical label viewed by the requestor and/or other location information indicating the incident specific location. At step 208, the dispatch device 104 causes at least the corresponding zone of the plurality of zones defined on the tactical map to be graphically accentuated. For example, a graphic accentuation may include changing the outline color of the indicated zone of the plurality of zones displayed on the tactical map. In some aspects, a graphical element such as an overlay highlight or flag may be depicted on the tactical map drawing a user's attention to the indicated zone. Since the plurality of zones are overlaid on an aerial map of the primary location, the user can rapidly contextualized the location of the zone with reference to the real-world features such as building structures and other structural features present at the primary location.

At step 210, the dispatch device 104 generates an incident specific tactical map that graphically accentuates the zones and/or other features relevant to the incident response request. At step 212, the dispatch device 104 transmits the incident response map to one or more of the responder devices 106 as an incident response dispatch message. The incident dispatch message is received by the one or more responder devices 106, which may include a responder vehicle mounted computing device, a mobile device of the responder, a tablet, or other like device having a display device that the responders can use to view and interact with the incident response map. The incident response map is a tactical map of the primary location that has been activated in response to the incident response request and annotated by the dispatch device 104. At step 214, the responder operating the responder device 106 is capable of interacting with the received incident response map at step 214 to learn about the primary location and plan for an approach to the incident specific location along with other emergency responders connected to the incident response system described herein.

### Aspects Related to the Incident Response System Pertaining to the Dispatcher

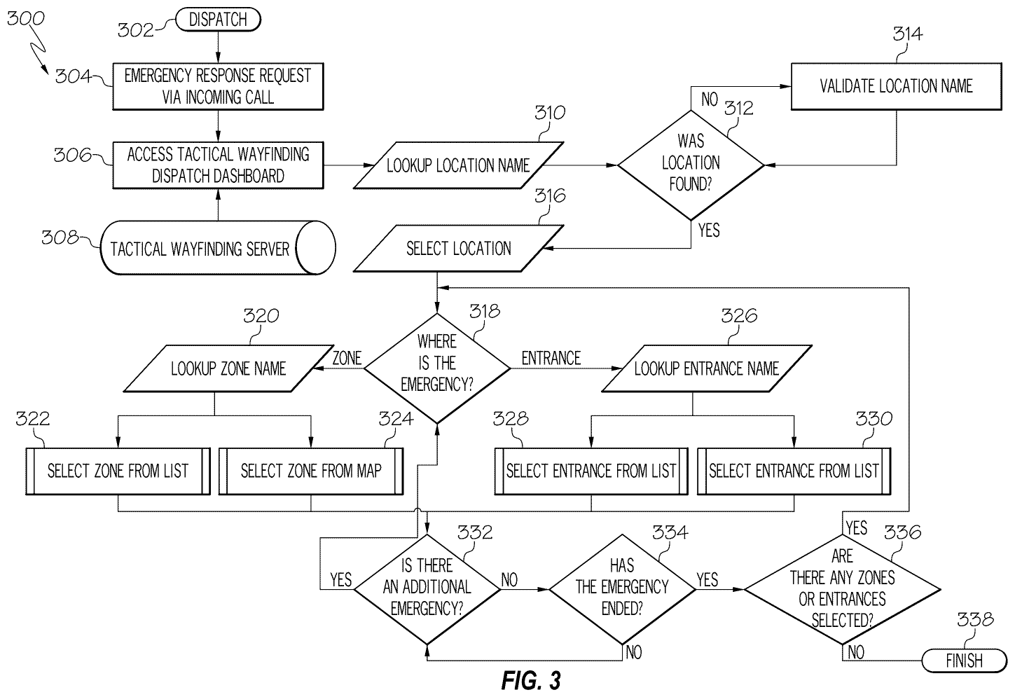

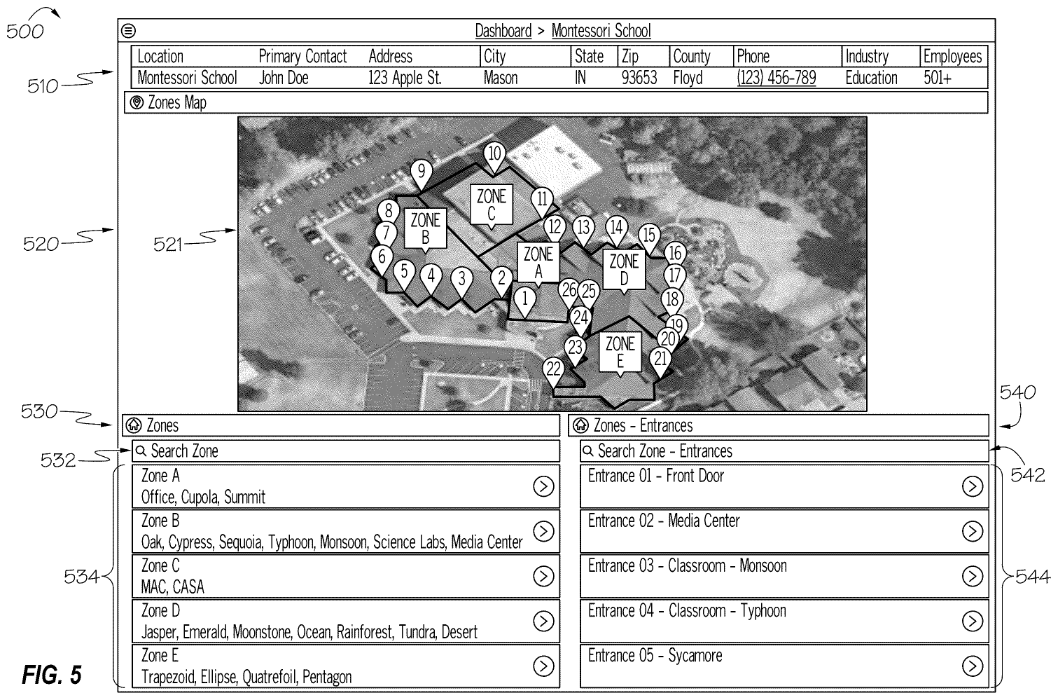

FIG. 3 depicts a block diagram 300 of an incident response system associated with the dispatcher. Aspects of the incident response system are described with reference to the block diagram 300 are further described with reference to FIGS. 4-8. FIGS. 4-8 depict illustrative user interfaces of the incident response system capable of interaction by the dispatcher via the dispatch device 104. FIG. 4 depicts a primary location selection menu. FIGS. 5-8 depict a dispatcher view of an incident response dashboard 500 displayed on a display device of the dispatch device 104 including the tactical map 520. References to FIGS. 4-8 are made with the discussion of the block diagram 300 of FIG. 3.

At block 302 in FIG. 3, a dispatcher, operating a dispatch device 104, activates the incident response system. At block 304, the dispatch device receives an incident response request, for example, as an incoming call, a text message, or other electronic communication. In some aspects, at block 306, a received incident response request triggers the incident response system to active the incident response dashboard 500, for example, as shown in FIGS. 4-8. The incident response dashboard 500 is launched by a server 308 configured to host the incident response system. Once the incident response dashboard 500 is launched, the dispatch device 104 provides a prompt for the dispatcher to submit a location query based on the incident response request information. The location query may include providing an interface 400 as shown in FIG. 4 listing primary locations setup for use (e.g., subscribed) with the incident response system. A location may be automatically selected from the list based on natural language processing of voice or text data received with the incident response request. In some aspects, the dispatcher may manually query and/or select a location corresponding to the primary location information provided in the incident response request. At block 312, the dispatch device 104 determines whether the location was found, for example, in a location database or subscribed location database. If the determination is “NO” at block 312, the process proceeds to block 314, where the name of the location is validated. Validation of the location may be conducted by communicating with the requestor device 102 and user operating the requestor device 102, who is submitting the incident response request. If an updated location or other identifying information is received the process returns to block 312. If the determination is “YES” at block 312, then the incident response dashboard 500 is caused to display the selected location 510 and corresponding information in addition to the tactical map 520 including an aerial image of the primary location and a plurality of zones (e.g., Zone A, Zone B, Zone C, Zone D, Zone E) overlaid on the aerial image 512. The incident response dashboard 500 further includes a zone selection menu 530 and an other features selection menu 540. The zone selection menu 530 includes a search field 532 where a keyword search is support. The zone selection menu 530 further includes a zone listing 534 that lists each of the plurality of zones defined for the primary location depicted by the tactical map 520. The other features selection menu 540 includes a search field 542 where a keyword search is support. The other features selection menu 540 further includes an other features listing 544 that lists each of the plurality of other features such as entrances, stairwells, and the like defined for the primary location depicted by the tactical map 520.

At block 316, selection of one or more locations indicated by the incident response request is made. The selection process includes determining whether the emergent incident is occurring in a zone or entrance, at block 318. If the location is in one or more zones, the process proceeds to block 320. At block 320 selection may be made from a zone listing 534 displayed in the incident response dashboard 500 depicted in FIG. 5. The zone listing 534 is defined by a data set 322. In some aspects the selection may be made from the plurality of zones (e.g., Zone A, Zone B, Zone C, Zone D, Zone E) overlaid on the aerial image 512 in the tactical map 520. The plurality of zones overlaid on the aerial image 512 in the tactical map 520 are defined by a data set 324.

At block 320 one or more zones corresponding to the incident response request is made. Selection of the one or more zones can be completed in a variety of ways. Zones may automatically selected and highlighted based on natural language processing of voice or text information provided with the incident response request. In some aspects, the dispatcher can search for the zones using the search field 532 and entering keywords, such as the zone name (e.g., “Zone A”) provided by incident response request, a location name such as gymnasium, office, science labs, or the like. Executing a search in the search field may cause the zone listing 534 to be filtered to relevant results. In some aspects, a zone from the zone listing 534 may be selected by directly selecting the graphic indication of the zone in the zone listing 534 or by selecting the portion of the tactical map corresponding to the desired zone.

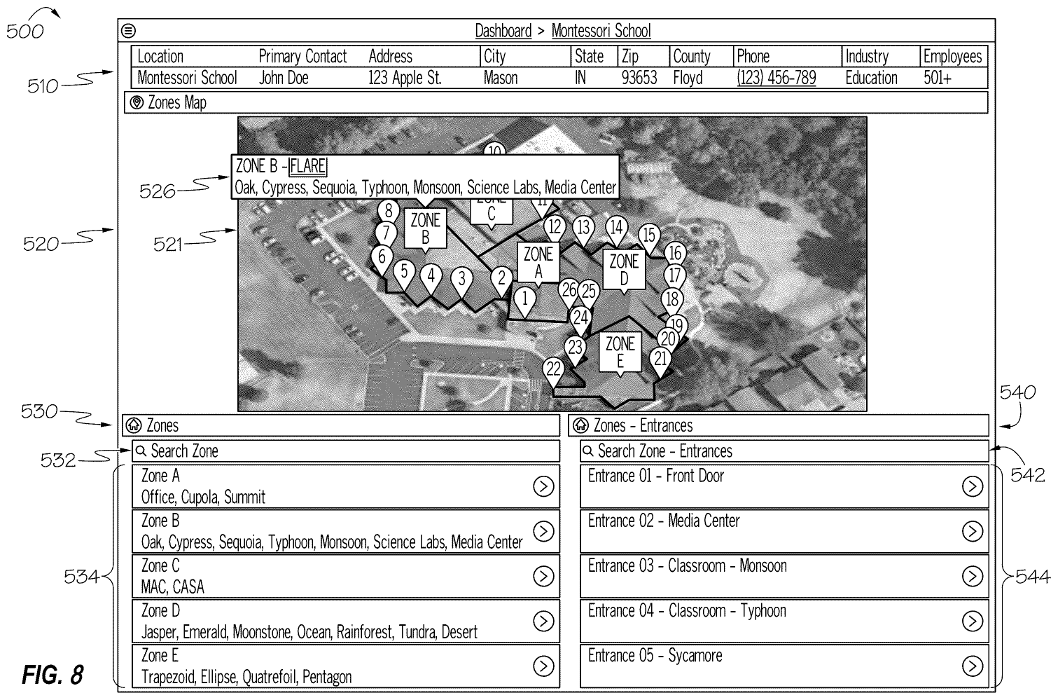

In some aspect, for example, as depicted in FIG. 8, the process of selecting a zone may include triggering a “Flare” by mousing-over the zone in the tactical map 520. The “Flare” may appear as a notification bubble 526 that includes information about the moused-over zone prior to selecting the zone.

If the display device is a touch-enabled display, a stylus or a user's finger may be used to make the selection. Similarly, another input device such as a mouse may be used to select the desired zone corresponding to the zone in the incident response request.

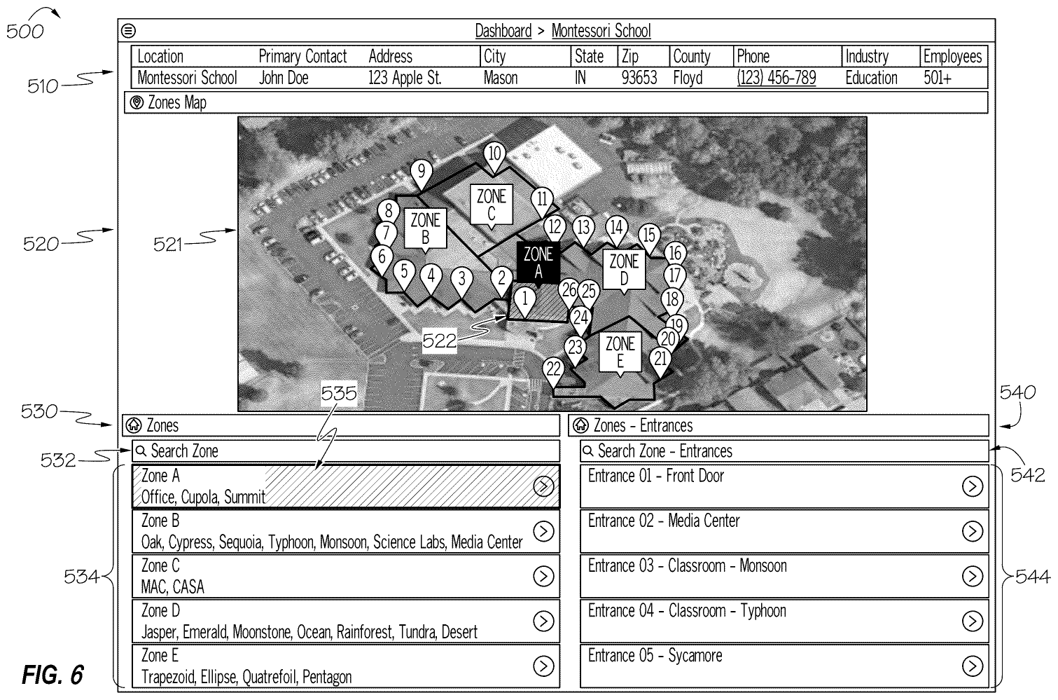

As shown in FIG. 6, when a zone is selected, for example, “Zone A” the selected zone 535 in the zone listing 534 is highlighted or otherwise graphically accentuated indicating its selection from the other zones in the zone listing 534. Additionally, the graphical representation of selected zone 522, for example, “Zone A” in the tactical map 520 is graphically accentuated by changing the color of the portion of the overlay or otherwise differentiating indication of the selected zone from the other zones depicted in the tactical map 520.

In some aspects, making a selection of a zone causes the other features selection menu 540 to be filtered such that the other features corresponding to the selected zone 522 in the other features listing 544 are sorted to the top of the list or displayed absent those other features not corresponding to the selected zone 522.

If the location of the emergent incident involves one or more other features such as an entrance or stairwell, the process proceeds to block 326 for selection of the relevant other features (e.g., one or more of the entrances 1-26 depicted in FIG. 5) from either the other features selection menu 540 or by selecting the one or more corresponding labels depicted in the tactical map 520. The other features listing 544 is defined by a data set 324.

At block 326, selection of the one or more other features (e.g., one or more of the entrances 1-26 depicted in FIG. 5) corresponding to the incident response request is made. Selection of the one or more other features can be completed in a variety of ways. The other features may be automatically selected and highlighted based on natural language processing of voice or text information provided with the incident response request. In some aspects, the dispatcher can search for the other features using the search field 542 and entering keywords, such as the entrance name (e.g., “Front Door”) provided by incident response request. Executing a search in the search field may cause the other features listing 544 to be filtered to relevant results. In some aspects, the other features from the other features listing 544 may be selected by directly selecting the graphic indication of the feature in the other features listing 544 or by selecting the label for the feature (e.g., one or more of the entrances 1-26 depicted in FIG. 5) depicted in the tactical map. If the display device is a touch-enabled display, a stylus or a user's finger may be used to make the selection. Similarly, another input device such as a mouse may be used to select the one or more other features.

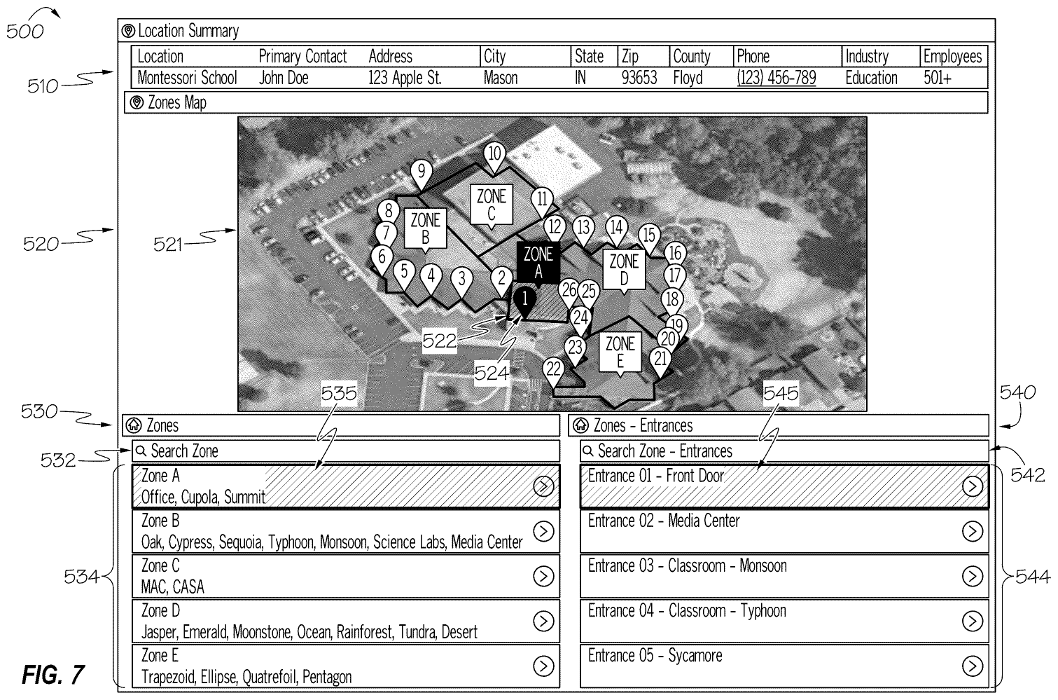

As shown in FIG. 7, when a feature such as an entrance is selected, for example, “Entrance 1”, the selected other feature 545 in the other features listing 544 is highlighted or otherwise graphically accentuated indicating its selection from the other zones in the other features listing 544. Additionally, the graphical representation of selected zone 522, for example, entrance label “1” in the tactical map 520 is graphically accentuated by changing the color of the portion of the overlay or otherwise differentiating indication of the selected zone from the other zones depicted in the tactical map 520.

Still referring to the block diagram 300 in FIG. 3, at block 332 the incident response system determines whether there are any additional emergency incidents that need to be indicated at the primary location. If the determination at block 332 is “YES”, the process returns to block 318. If the determination at block 332 is “NO”, the process proceeds to block 334. At block 334, the incident response system determines, for example, with a query to the dispatcher, whether the emergent incident has ended. If the determination at block 334 is “NO”, the process returns to block 332. If the determination at block 334 is “YES”, the process proceeds to block 336. At block 336, the incident response system determines whether any zones or other features such as entrances are selected. If the determination at block 336 is “YES”, the process returns to block 318. If the determination at block 336 is “NO”, the process to end the incident response process at block 338.

### Aspects Related to the Incident Response System Pertaining to the Responder

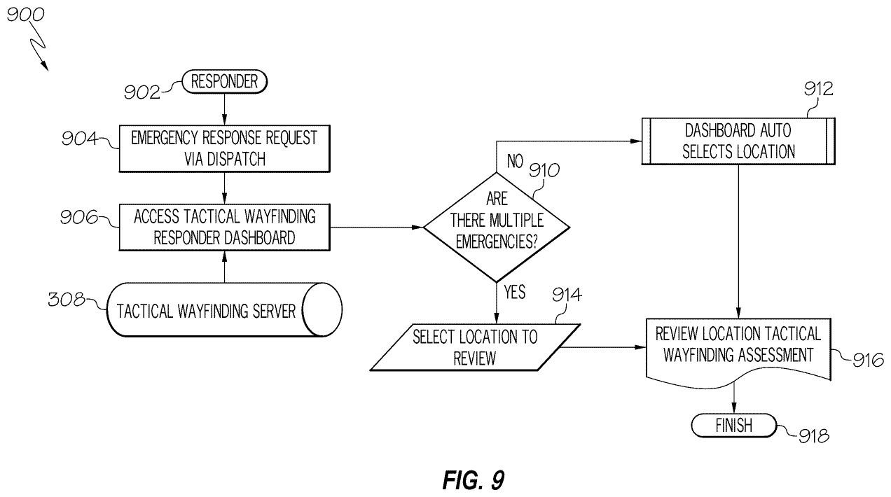

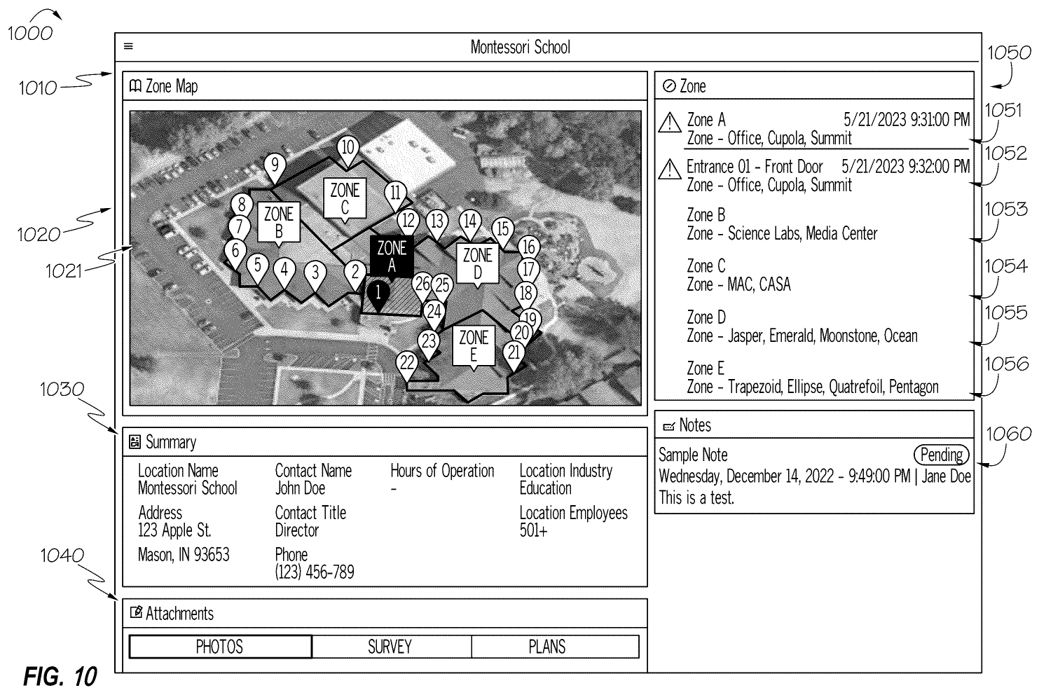

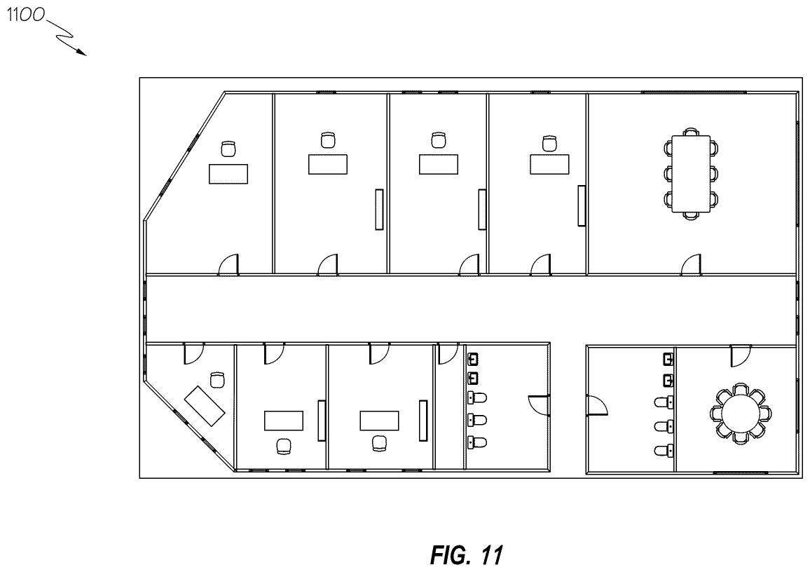

FIG. 9 depicts a block diagram 900 of an incident response system associated with the one or more responders. Responders such as emergency responders including firefighters, paramedics, police officers, and the like are equipped with a responder device 106 such as in-vehicle devices, mobile devices or the like that are in communication with the dispatch device 104. Aspects of the incident response system are described with reference to the block diagram 900 are further described with reference to FIGS. 10-12. FIG. 10 depicts an illustrative incident response dashboard 1000 of the incident response system capable of interaction by the responders via the responder device 106. FIG. 11 depicts an illustrative example of the display device of the responder device 106 providing an example of a floor plan of corresponding to a selected zone. The incident response dashboard 500 is supported by a server 308 configured to host the incident response system.

At block 902 in FIG. 9, a responder, operating a responder device 106, activates the incident response system. For example, the responder may open an application or access a web portal hosting the incident response system. At block 904, the responder device 106 receives an incident response dispatch from the dispatch device 104. In some aspects, at block 306, a received incident response dispatch triggers the incident response system to active the incident response dashboard 1000 for the responder, for example, as shown in FIG. 10. The incident response dispatch includes an incident response map, which includes the information the dispatch device 104 has obtained from one, or more incident response requests associated with the emergent incident. The incident response map is a tactical map 1020 of the primary location that includes one or more graphically accentuated zones and other features such as entrances that correspond to the emergent incident that the responder is being dispatched to provide assistance. The tactical map 1020 includes the aerial map 1021 of the primary location and graphically accentuated zones and/or other features corresponding to the emergent incidents the responder is being dispatched for. If the determination at block 910 is “NO” the responder may be prompted to select one of the locations or the incident response system may automatically select of one of the multiple locations at block 912. Indication of the location that is selected and displayed on the incident response dashboard 1000 is indicated at 1010 and a summary of the location is provided in the summary section 1030. The summary section 1030 includes the location name, street address, contact name(s), contact title(s), contact phone number(s), hours of operation, the type of industry at the location, the estimated population of persons located at the location, and/or the like. Once on of the one or more locations is selected, the process proceeds to block 916.

If the determination at block 910 is “YES”, there is only one location for the responder to review at block 914. At block 914, the incident response dashboard 1000 provides the responder with information the dispatcher compiled regarding the emergent incident. At block 916, the responder is able to review location information through provided through the tactical map 1020, the summary section 1030, zone and entrance specific information provided in the zone summary section 1050, and any notes obtained and added to the location based on the onsite assessment in section 1060.

The zone summary section 1050 includes a list of the zones and other features present in the tactical map 1020. The zones and other features (e.g., Zone A and Entrance 01) that have been indicated by the dispatcher as corresponding to the emergent incident are presented at the top of the list and include a symbol or other indicator that indicates selection of the zones and other features. The zone summary section 1050 may also include short summaries of each of the zones and other features for the responders' reference.

The incident response dashboard may also include attachments that are accessible by the responders. The attachment section 1040 may include a one or more lists of files including photos, surveys, and/or floor plans that are accessible by the responder. For example, selecting an attachment from the attachment section 1040 causes the attachment to open on display device of the responder device 106. For example, FIG. 11 depicts an illustrative example of a floor plan 1100 selected from the attachment section 1040.

### Example Operations of a Dispatch Device

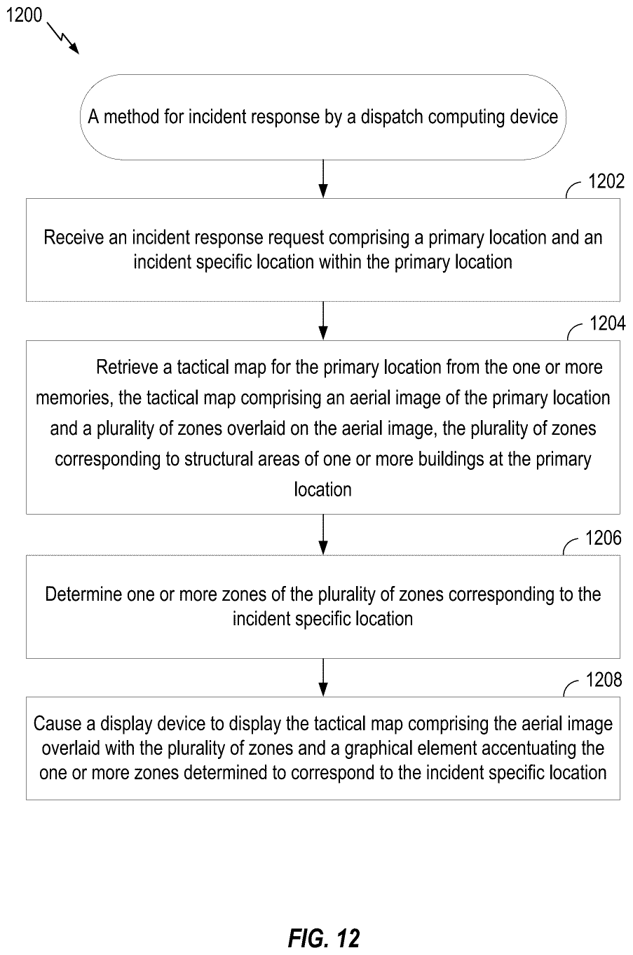

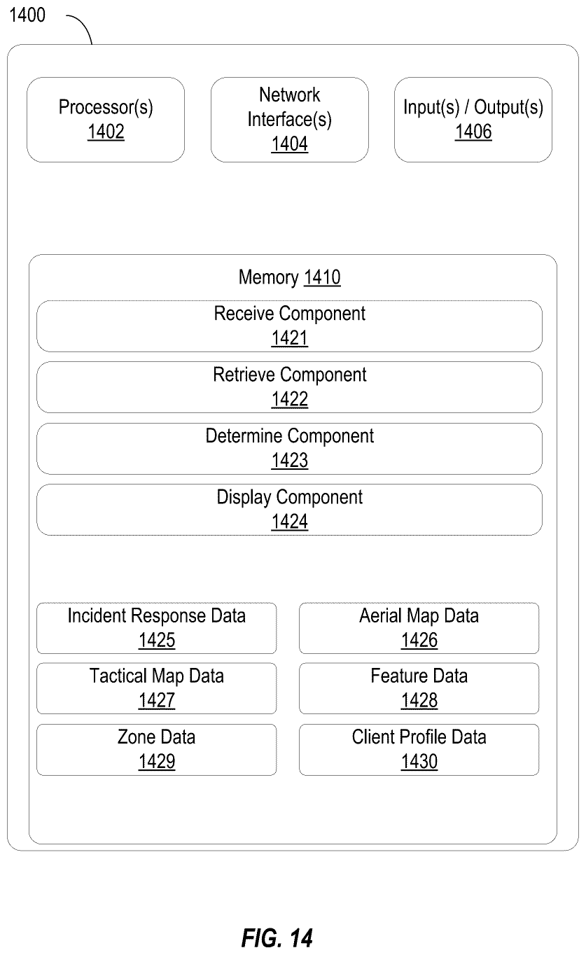

FIG. 12 shows a method 1200 for incident response request by a dispatch device, such as dispatch device 104 of FIGS. 2 and 14.

Method 1200 begins at step 1202 with receiving an incident response request comprising a primary location and an incident specific location within the primary location.

Method 1200 then proceeds to step 1204 with retrieving a tactical map for the primary location from the one or more memories, the tactical map comprising an aerial image of the primary location and a plurality of zones overlaid on the aerial image, the plurality of zones corresponding to structural areas of one or more buildings at the primary location.

Method 1200 then proceeds to step 1206 with determining one or more zones of the plurality of zones corresponding to the incident specific location.

Method 1200 then proceeds to step 1208 with causing a display device to display the tactical map comprising the aerial image overlaid with the plurality of zones and a graphical element accentuating the one or more zones determined to correspond to the incident specific location.

In certain aspects, the tactical map includes a plurality of entrances each represented by an indicator positioned on the aerial image at a location of an entrance.

In certain aspects, method 1200 further includes causing the display device displaying the tactical map to graphically accentuate one or more of the indicators for one or more of the plurality of entrances corresponding to the one or more zones determined to correspond to the incident specific location.

In certain aspects, method 1200 further includes causing the display device to display a dashboard to a user, the dashboard comprising the tactical map, a first selectable menu providing a listing of the plurality of zones, and a second selectable menu providing a listing of the plurality of entrances, receiving, from an input device, a selection of one of the plurality of zones or a selection of one of the plurality of entrances, and causing the display device displaying the tactical map to graphically accentuate the selected one of the plurality of zones or the selected one of the plurality of entrances.

In certain aspects, method 1200 further includes in response to receiving the selection of one of the plurality of zones, filtering the second selectable menu to list one or more of the plurality of entrances corresponding to the selected one of the plurality of zones.

In certain aspects, method 1200 further includes causing the display device to display a dashboard to a user, the dashboard comprising the tactical map comprising the aerial image of the primary location, the plurality of zones, and a plurality of entrances each represented by an indicator positioned on the aerial image at a location of an entrance; and receiving, from an input device, a selection of one of the plurality of zones or one of the plurality of entrances, wherein the selection is made by the input device activating a portion of the tactical map displayed on the display device.

In certain aspects, method 1200 further includes in response to the selection of one of the plurality of zones or one of the plurality of entrances, causing the display device displaying the tactical map to graphically accentuate the selected one of the plurality of zones or the selected one of the plurality of entrances.

In certain aspects, method 1200 further includes in response to the selection of one of the plurality of zones or one of the plurality of entrances, cause the display device to display information pertaining to the selected one of the plurality of zones or the selected one of the plurality of entrances.

In certain aspects, method 1200 further includes causing a transceiver to send the tactical map comprising the aerial image overlaid with the plurality of zones and the graphical element accentuating the one or more zones determined to correspond to the incident specific location to a user equipment of a responder.

In certain aspects, a processing system 1400 of FIG. 14 is a dispatch device 104 of FIG. 1, which includes various components operable, configured, or adapted to perform the method 1200, may perform method 1200, or any aspect related to it. The processing system 1400 is described below in further detail.

Note that FIG. 12 is just one example of a method, and other methods including fewer, additional, or alternative steps are possible consistent with this disclosure.

### Example Operations of a Responder Device

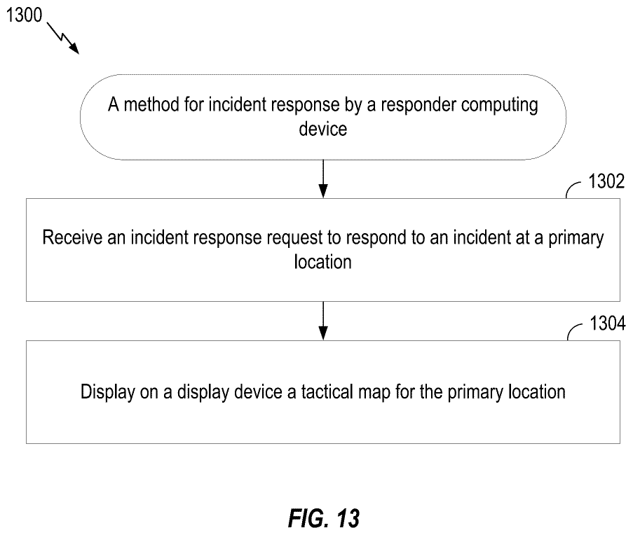

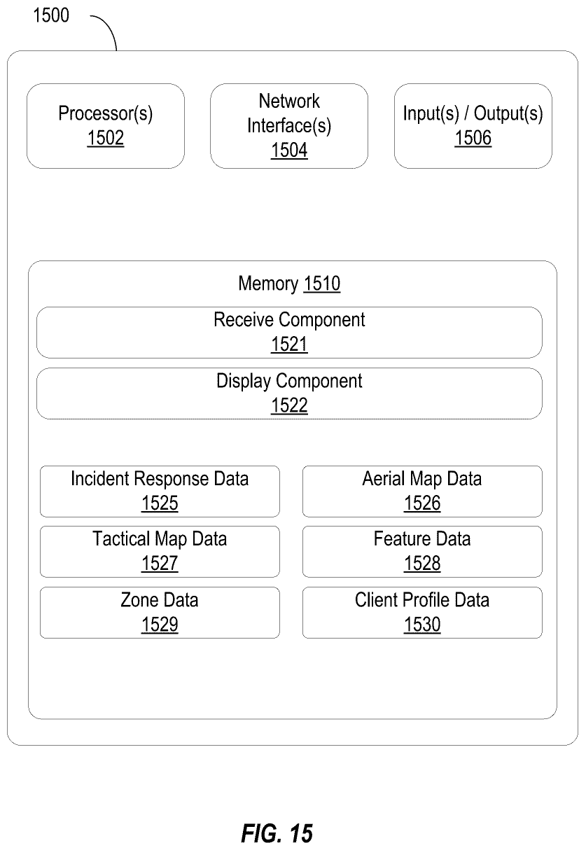

FIG. 13 shows a method 1300 for incident response request by a responder device, such as responder device 106 of FIGS. 2 and 15.

Method 1300 begins at step 1302 with receiving an incident response request to respond to an incident at a primary location.

Method 1300 then proceeds to step 1304 with displaying on a display device a tactical map for the primary location.

In certain aspects, the tactical map comprises an aerial image of the primary location and a plurality of zones overlaid on the aerial image.

In certain aspects, the plurality of zones corresponding to structural areas of one or more buildings at the primary location.

In certain aspects, a graphical element accentuating one or more zones corresponding to an incident specific location within the primary location.

In certain aspects, the tactical map further comprises a plurality of entrances each represented by an indicator positioned on the aerial image at a location of an entrance.

In certain aspects, method 1300 further includes causing the display device to display a dashboard to a user, the dashboard comprising the tactical map comprising the aerial image of the primary location, the plurality of zones, and a plurality of entrances each represented by an indicator positioned on the aerial image at a location of an entrance; and receiving, from an input device, a selection of one of the plurality of zones or one of the plurality of entrances, wherein the selection is made by the input device activating a portion of the tactical map displayed on the display device.

In certain aspects, method 1300 further includes in response to the selection of one of the plurality of zones or one of the plurality of entrances, causing the display device displaying the tactical map to graphically accentuate the selected one of the plurality of zones or the selected one of the plurality of entrances.

In certain aspects, method 1300 further includes in response to the selection of one of the plurality of zones or one of the plurality of entrances, causing the display device to display information pertaining to the selected one of the plurality of zones or the selected one of the plurality of entrances.

In certain aspects, method 1300 further includes in response to the selection of one of the plurality of zones, causing the display device to display a floor plan of the selected one of the plurality of zones.

In certain aspects, a processing system 1500 of FIG. 15 is a responder device 106 of FIG. 1, which includes various components operable, configured, or adapted to perform the method 1300, may perform method 1300, or any aspect related to it. The processing system 1500 is described below in further detail.

Note that FIG. 1300 is just one example of a method, and other methods including fewer, additional, or alternative steps are possible consistent with this disclosure.

### Example Processing System for a Dispatch Device

FIG. 14 depicts an example processing system 1400 configured to perform the methods described herein. The processing system 1400 may be dispatch device 104 as depicted with reference to FIGS. 1 and 2, and described herein.

Processing system 1400 includes one or more processors 1402. Generally, processor(s) 1402 may be configured to execute computer-executable instructions (e.g., software code) to perform various functions, as described herein.

In the depicted example, computer-readable medium/memory 1410 includes a receive component 1421, a retrieve component 1422, a determine component 1423, and display component 1424. Each of the components 1421-1424 of the memory 1410 may store code (e.g., executable instructions) for receiving, code for retrieving, code for determining, and code for displaying. Processing of the code may enable and cause the processing system 1400 to perform the method 1200 described with respect to FIG. 12, or any aspect related to it.

The one or more processors 1402 include circuitry configured to implement (e.g., execute) the code stored in the computer-readable medium/memory 1410, including circuitry for receiving, circuitry for retrieving, circuitry for determining, and circuitry for displaying. Processing with circuitry may enable and cause the processing system 1400 to perform the method 1200 described with respect to FIG. 12, or any aspect related to it.

Processing system 1400 further includes a network interface(s) 1404, which generally provides data access to any sort of data network, including personal area networks (PANs), local area networks (LANs), wide area networks (WANs), the Internet, and the like.

Processing system 1400 further includes input(s) and output(s) 1406, which generally provide means for providing data to and from processing system 1400, such as via connection to computing device peripherals, including user interface peripherals such as a keyboard, a mouse, other input devices, display devices and the like.

Processing system further includes a memory 1410 configured to store various types of components and data.

In this example, memory 1410 includes a receive component 1421, a retrieve component 1422, a determine component 1423, and display component 1424.

The receive component 1421 is configured to perform at least step 1202 of method 1200 depicted and described with reference to FIG. 12. The retrieve component 1422 is configured to perform at least step 1204 of method 1200 depicted and described with reference to FIG. 12. The determine component 1423 is configured to perform at least step 1206 of method 1200 depicted and described with reference to FIG. 12. The display component 1424 is configured to perform at least step 1208 of method 1200 depicted and described with reference to FIG. 12.

In this example, memory 1410 also includes incident response data 1425, aerial map data 1426, tactical map data 1427, feature data 1428, zone data 1429, and client profile data 1430.

Processing system 1400 may be implemented in various ways. For example, processing system 1400 may be implemented within on-site, remote, or cloud-based processing equipment. Processing system 1400 may be a dispatch device 104.

Processing system 1400 is just one example, and other configurations are possible. For example, in alternative embodiments, aspects described with respect to processing system 1400 may be omitted, added, or substituted for alternative aspects.

### Example Processing System for a Responder Device

FIG. 15 depicts an example processing system 1500 configured to perform the methods described herein. The processing system 1500 may be responder device 106 as depicted with reference to FIGS. 1 and 2, and described herein.

Processing system 1500 includes one or more processors 1502. Generally, processor(s) 1502 may be configured to execute computer-executable instructions (e.g., software code) to perform various functions, as described herein.

In the depicted example, computer-readable medium/memory 1510 includes at least a receive component 1521 and a display component 1522. Each of the components 1521-1522 of the memory 1510 may store code (e.g., executable instructions) for receiving and code for displaying. Processing of the code may enable and cause the processing system 1500 to perform the method 1300 described with respect to FIG. 13, or any aspect related to it.

The one or more processors 1502 include circuitry configured to implement (e.g., execute) the code stored in the computer-readable medium/memory 1510, including circuitry for receiving and circuitry for displaying. Processing with circuitry may enable and cause the processing system 1500 to perform the method 1300 described with respect to FIG. 13, or any aspect related to it.

Processing system 1500 further includes a network interface(s) 1504, which generally provides data access to any sort of data network, including personal area networks (PANs), local area networks (LANs), wide area networks (WANs), the Internet, and the like.

Processing system 1500 further includes input(s) and output(s) 1506, which generally provide means for providing data to and from processing system 1500, such as via connection to computing device peripherals, including user interface peripherals such as a keyboard, a mouse, other input devices, display devices and the like.

Processing system further includes a memory 1510 configured to store various types of components and data.

In this example, memory 1510 includes a receive component 1521 and a display component 1522.

The receive component 1521 is configured to perform at least step 1302 of method 1300 depicted and described with reference to FIG. 13. The display component 1522 is configured to perform at least step 1304 of method 1300 depicted and described with reference to FIG. 13.

In this example, memory 1510 also includes incident response data 1525, aerial map data 1526, tactical map data 1527, feature data 1528, zone data 1529, and client profile data 1530.

Processing system 1500 may be implemented in various ways. For example, processing system 1500 may be implemented within on-site, remote, or cloud-based processing equipment. Processing system 1500 may be a responder device 106.

Processing system 1500 is just one example, and other configurations are possible. For example, in alternative embodiments, aspects described with respect to processing system 1500 may be omitted, added, or substituted for alternative aspects.

### Example Clauses

Implementation examples are described in the following numbered clauses:

Clause 1: A method for incident response by a dispatch computing device, the method comprising: receiving an incident response request comprising a primary location and an incident specific location within the primary location; retrieving a tactical map for the primary location from the one or more memories, the tactical map comprising an aerial image of the primary location and a plurality of zones overlaid on the aerial image, the plurality of zones corresponding to structural areas of one or more buildings at the primary location; determining one or more zones of the plurality of zones corresponding to the incident specific location; and causing a display device to display the tactical map comprising the aerial image overlaid with the plurality of zones and a graphical element accentuating the one or more zones determined to correspond to the incident specific location.

Clause 2: The method of claim 1, wherein the tactical map further comprises a plurality of entrances each represented by an indicator positioned on the aerial image at a location of an entrance.

Clause 3. The method of Clause 2, further comprising causing the display device displaying the tactical map to graphically accentuate one or more of the indicators for one or more of the plurality of entrances corresponding to the one or more zones determined to correspond to the incident specific location.

Clause 4: The method of Clause 2, further comprising causing the display device to display a dashboard to a user, the dashboard comprising the tactical map, a first selectable menu providing a listing of the plurality of zones, and a second selectable menu providing a listing of the plurality of entrances, receiving, from an input device, a selection of one of the plurality of zones or a selection of one of the plurality of entrances, and causing the display device displaying the tactical map to graphically accentuate the selected one of the plurality of zones or the selected one of the plurality of entrances.

Clause 5: The method of Clause 4, further comprising, in response to receiving the selection of one of the plurality of zones, filtering the second selectable menu to list one or more of the plurality of entrances corresponding to the selected one of the plurality of zones.

Clause 6: The method of any one of Clauses 1-5, further comprising: causing the display device to display a dashboard to a user, the dashboard comprising the tactical map comprising the aerial image of the primary location, the plurality of zones, and a plurality of entrances each represented by an indicator positioned on the aerial image at a location of an entrance; and receiving, from an input device, a selection of one of the plurality of zones or one of the plurality of entrances, wherein the selection is made by the input device activating a portion of the tactical map displayed on the display device.

Clause 7: The method of Clause 6, further comprising, in response to the selection of one of the plurality of zones or one of the plurality of entrances, causing the display device displaying the tactical map to graphically accentuate the selected one of the plurality of zones or the selected one of the plurality of entrances.

Clause 8: The method of Clause 6, further comprising, in response to the selection of one of the plurality of zones or one of the plurality of entrances, cause the display device to display information pertaining to the selected one of the plurality of zones or the selected one of the plurality of entrances.

Clause 9: The method of any one of Clauses 1-8, further comprising causing a transceiver to send the tactical map comprising the aerial image overlaid with the plurality of zones and the graphical element accentuating the one or more zones determined to correspond to the incident specific location to a user equipment of a responder.

Clause 10. A method for incident response by a responder computing device, the method comprising: receiving an incident response request to respond to an incident at a primary location; and displaying on a display device a tactical map for the primary location, wherein: the tactical map comprises an aerial image of the primary location and a plurality of zones overlaid on the aerial image, the plurality of zones corresponding to structural areas of one or more buildings at the primary location, and a graphical element accentuates one or more zones corresponding to an incident specific location within the primary location.

Clause 11: The method of Clause 10, wherein the tactical map further comprises a plurality of entrances each represented by an indicator positioned on the aerial image at a location of an entrance.

Clause 12: The method of Clause 11, further comprising causing the display device displaying the tactical map to graphically accentuate one or more of the indicators for one or more of the plurality of entrances associated with the one or more zones corresponding to the incident specific location.

Clause 13: The method of any one of Clauses 10-12, further comprising: causing the display device to display a dashboard to a user, the dashboard comprising the tactical map comprising the aerial image of the primary location, the plurality of zones, and a plurality of entrances each represented by an indicator positioned on the aerial image at a location of an entrance; and receiving, from an input device, a selection of one of the plurality of zones or one of the plurality of entrances, wherein the selection is made by the input device activating a portion of the tactical map displayed on the display device.

Clause 14: The method of Clause 13, further comprising, in response to the selection of one of the plurality of zones or one of the plurality of entrances, causing the display device displaying the tactical map to graphically accentuate the selected one of the plurality of zones or the selected one of the plurality of entrances.

Clause 15: The method of Clause 13, further comprising, in response to the selection of one of the plurality of zones or one of the plurality of entrances, causing the display device to display information pertaining to the selected one of the plurality of zones or the selected one of the plurality of entrances.

Clause 16: The method of claim 13, further comprising, in response to the selection of one of the plurality of zones, causing the display device to display a floor plan of the selected one of the plurality of zones.

Clause 17: An apparatus, comprising: a memory comprising executable instructions; and a processor configured to execute the executable instructions and cause the apparatus to perform a method in accordance with any one of clauses 1-16.

Clause 18: An apparatus, comprising means for performing a method in accordance with any one of clauses 1-16.

Clause 19: A non-transitory computer-readable medium storing program code for causing a processing system to perform the steps of any one of clauses 1-16.

Clause 20: A computer program product embodied on a computer-readable storage medium comprising code for performing a method in accordance with any one of clauses 1-16.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. In addition, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An incident response system comprising a computing device comprising one or more memories comprising processor-executable instructions and one or more processors configured to execute the processor-executable instructions and cause the computing device to:
receive an incident response request comprising a primary location and an incident specific location within the primary location;
retrieve a tactical map for the primary location from the one or more memories, the tactical map comprising an aerial image of the primary location and a plurality of zones overlaid on the aerial image, the plurality of zones corresponding to structural areas of one or more buildings at the primary location;
determine one or more zones of the plurality of zones corresponding to the incident specific location; and
cause a display device to display the tactical map comprising the aerial image overlaid with the plurality of zones and a graphical element accentuating the one or more zones determined to correspond to the incident specific location.

2. The incident response system of claim 1, wherein the tactical map further comprises a plurality of entrances each represented by an indicator positioned on the aerial image at a location of an entrance.

3. The incident response system of claim 2, wherein the one or more processors are configured to execute the processor-executable instructions that further cause the computing device to cause the display device displaying the tactical map to graphically accentuate one or more of the indicators for one or more of the plurality of entrances corresponding to the one or more zones determined to correspond to the incident specific location.

4. The incident response system of claim 2, wherein the one or more processors are configured to execute the processor-executable instructions that further cause the computing device to:
cause the display device to display a dashboard to a user, the dashboard comprising the tactical map, a first selectable menu providing a listing of the plurality of zones, and a second selectable menu providing a listing of the plurality of entrances,
receive, from an input device, a selection of one of the plurality of zones or a selection of one of the plurality of entrances, and
cause the display device displaying the tactical map to graphically accentuate the selected one of the plurality of zones or the selected one of the plurality of entrances.

5. The incident response system of claim 4, wherein the one or more processors are configured to execute the processor-executable instructions that further cause the computing device to: in response to receiving the selection of one of the plurality of zones, filter the second selectable menu to list one or more of the plurality of entrances corresponding to the selected one of the plurality of zones.

6. The incident response system of claim 1, wherein the one or more processors are configured to execute the processor-executable instructions that further cause the computing device to:
cause the display device to display a dashboard to a user, the dashboard comprising the tactical map comprising the aerial image of the primary location, the plurality of zones, and a plurality of entrances each represented by an indicator positioned on the aerial image at a location of an entrance; and
receive, from an input device, a selection of one of the plurality of zones or one of the plurality of entrances, wherein the selection is made by the input device activating a portion of the tactical map displayed on the display device.

7. The incident response system of claim 6, wherein the one or more processors are configured to execute the processor-executable instructions that further cause the computing device to: in response to the selection of one of the plurality of zones or one of the plurality of entrances, cause the display device displaying the tactical map to graphically accentuate the selected one of the plurality of zones or the selected one of the plurality of entrances.

8. The incident response system of claim 6, wherein the one or more processors are configured to execute the processor-executable instructions that further cause the computing device to: in response to the selection of one of the plurality of zones or one of the plurality of entrances, cause the display device to display information pertaining to the selected one of the plurality of zones or the selected one of the plurality of entrances.

9. The incident response system of claim 1, wherein the one or more processors are configured to execute the processor-executable instructions that further cause the computing device to: cause a transceiver to send the tactical map comprising the aerial image overlaid with the plurality of zones and the graphical element accentuating the one or more zones determined to correspond to the incident specific location to a user equipment of a responder.

10. An incident response system comprising a computing device comprising one or more memories comprising processor-executable instructions and one or more processors configured to execute the processor-executable instructions and cause the computing device to:
receive an incident response request to respond to an incident at a primary location; and
display on a display device a tactical map for the primary location, wherein:
the tactical map comprises an aerial image of the primary location and a plurality of zones overlaid on the aerial image,
the plurality of zones corresponding to structural areas of one or more buildings at the primary location, and
a graphical element accentuating one or more zones corresponding to an incident specific location within the primary location.

11. The incident response system of claim 10, wherein the tactical map further comprises a plurality of entrances each represented by an indicator positioned on the aerial image at a location of an entrance.

12. The incident response system of claim 11, wherein the one or more processors are configured to execute the processor-executable instructions that further cause the computing device to cause the display device displaying the tactical map to graphically accentuate one or more of the indicators for one or more of the plurality of entrances associated with the one or more zones corresponding to the incident specific location.

13. The incident response system of claim 10, wherein the one or more processors are configured to execute the processor-executable instructions that further cause the computing device to:
cause the display device to display a dashboard to a user, the dashboard comprising the tactical map comprising the aerial image of the primary location, the plurality of zones, and a plurality of entrances each represented by an indicator positioned on the aerial image at a location of an entrance; and
receive, from an input device, a selection of one of the plurality of zones or one of the plurality of entrances, wherein the selection is made by the input device activating a portion of the tactical map displayed on the display device.

14. The incident response system of claim 13, wherein the one or more processors are configured to execute the processor-executable instructions that further cause the computing device to: in response to the selection of one of the plurality of zones or one of the plurality of entrances, cause the display device displaying the tactical map to graphically accentuate the selected one of the plurality of zones or the selected one of the plurality of entrances.

15. The incident response system of claim 13, wherein the one or more processors are configured to execute the processor-executable instructions that further cause the computing device to: in response to the selection of one of the plurality of zones or one of the plurality of entrances, cause the display device to display information pertaining to the selected one of the plurality of zones or the selected one of the plurality of entrances.

16. The incident response system of claim 13, wherein the one or more processors are configured to execute the processor-executable instructions that further cause the computing device to: in response to the selection of one of the plurality of zones, cause the display device to display a floor plan of the selected one of the plurality of zones.

17. A method for incident response by a dispatch device, the method comprising:
receiving an incident response request comprising a primary location and an incident specific location within the primary location;
retrieving a tactical map for the primary location from one or more memories of the dispatch device, the tactical map comprising an aerial image of the primary location and a plurality of zones overlaid on the aerial image, the plurality of zones corresponding to structural areas of one or more buildings at the primary location;
determining one or more zones of the plurality of zones corresponding to the incident specific location; and
causing a display device to display the tactical map comprising the aerial image overlaid with the plurality of zones and a graphical element accentuating the one or more zones determined to correspond to the incident specific location.

18. The method of claim 17, wherein the tactical map further comprises a plurality of entrances each represented by an indicator positioned on the aerial image at a location of an entrance.

19. The method of claim 18, further comprising causing the display device displaying the tactical map to graphically accentuate one or more of the indicators for one or more of the plurality of entrances corresponding to the one or more zones determined to correspond to the incident specific location.

20. The method of claim 18, further comprising:
causing the display device to display a dashboard to a user, the dashboard comprising the tactical map, a first selectable menu providing a listing of the plurality of zones, and a second selectable menu providing a listing of the plurality of entrances,
receiving, from an input device, a selection of one of the plurality of zones or a selection of one of the plurality of entrances, and
causing the display device displaying the tactical map to graphically accentuate the selected one of the plurality of zones or the selected one of the plurality of entrances.
